(19) United States
(12) Patent Application Publication
(10) Pub. No.: US 2010/0306856 A1
(43) Pub. Date: Dec. 2, 2010

(54) SYSTEM AND METHOD FOR FILTERING EMAIL DATA

(75) Inventors: Sorin Suciu, Bucharest (RO); Valeriu Zabalan, Bucharest (RO)

Correspondence Address: PERKINS COIE LLP;PATENT-SEA, P.O. BOX 1247, SEATTLE, WA, 98111-1247, US

(73) Assignee: GECAD TECHNOLOGIES SA, Bucharest 2 (RO)

(21) Appl. No.: 12/739,714

(22) PCT Filed: Oct. 23, 2007
(86) PCT No.: PCT/IB2007/003178

§ 371 Date: Aug. 17, 2010

(51) Int. Cl. G06F 15/16; G06F 21/00

(52) U.S. Cl. 726/27; 709/206

(57) ABSTRACT

A software and/or hardware facility for filtering email data. The facility receives an indication of an SMTP event associated with an email and processes a script corresponding to the SMTP event. The script is comprised of a language for processing emails and may include one or more filters. If the script includes one or more filters, the facility executes the one or more filters and takes action on the associated email in accordance with the executed one or more filters. The action taken by the facility includes configuring the email system to affect not only the associated email but other emails.

### TECHNICAL FIELD

The present invention is directed generally toward electronic messaging systems.

### BACKGROUND

Many organizations employ electronic messaging systems to provide email services for their users. Electronic messaging systems receive and send numerous emails for and on behalf of their users. With the increasing use of email as a form of business and personal communication, one of the challenges that email users face is managing the intake and processing of emails. As the number of emails that users receive multiplies, email systems have had to provide tools that allow users or email system administrators to effectively manage the emails. For example, electronic messaging systems typically employ various techniques to filter or process emails that the systems send and receive. These techniques can be used to route emails to their proper destinations as well as to filter unsolicited commercial emails. Routing emails allow users to automatically group like emails in common locations, forward emails to other accounts, provide error or other notices to email senders, and otherwise manage sent or received messages. Filtering emails allows users to automatically remove or otherwise process received messages having little or no value to the users. While such email filtering techniques have proven to be valuable, improvements in email filtering techniques would always be beneficial, particularly if the improvements minimize the amount of user and administrator time that must be devoted to managing emails.

### BRIEF DESCRIPTION OF THE DRAWINGS

FIG. 1 is a block diagram that illustrates components of a facility for filtering emails.

FIGS. 2A and 2B are flow diagrams of processes implemented by the facility for filtering emails.

FIG. 3 is a block diagram that illustrates the flow of emails through the facility.

FIGS. 4A and 4B are a flow diagram of another process implemented by the facility for filtering emails.

FIG. 5 is a representative screenshot depicting an interface implemented by the facility for administering email filters.

FIGS. 6A and 6B are representative screenshots depicting another interface implemented by the facility for administering email filters.

### DETAILED DESCRIPTION

A software and/or hardware facility for filtering email data is described herein. The facility receives an indication of an SMTP event associated with an email and processes a script corresponding to the SMTP event. The script is comprised of a language for processing emails and may include one or more filters. If the script includes one or more filters, the facility executes the one or more filters and takes action on the associated email in accordance with the executed one or more filters. The action taken by the facility includes configuring the email system to affect not only the associated email but other emails.

A method of filtering emails in an email system having a plurality of configuration settings is also described herein. The method includes receiving an email, thereby triggering an SMTP event, and accessing one or more event rules in order to identify an event rule corresponding to the triggered SMTP event. The identified event rule includes one or more filters that when executed cause an action to be taken on an email. The method further includes executing an appropriate filter within the event rule and taking action on the received email in accordance with the executed filter, which includes configuring the email system.

In some embodiments, the facility implements a method of processing emails in an email system. The method includes retrieving an event rule corresponding to an SMTP event, wherein the event rule includes a call to a function that sets a value of at least one variable. The method further includes receiving an email, thereby triggering the SMTP event, and executing the event rule in response to the SMTP event. Executing the event rule includes setting the value of the at least one variable, and taking action on the received email. The action taken by the facility is determined entirely by the value of the at least one variable.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

### 1. OVERVIEW OF THE FACILITY

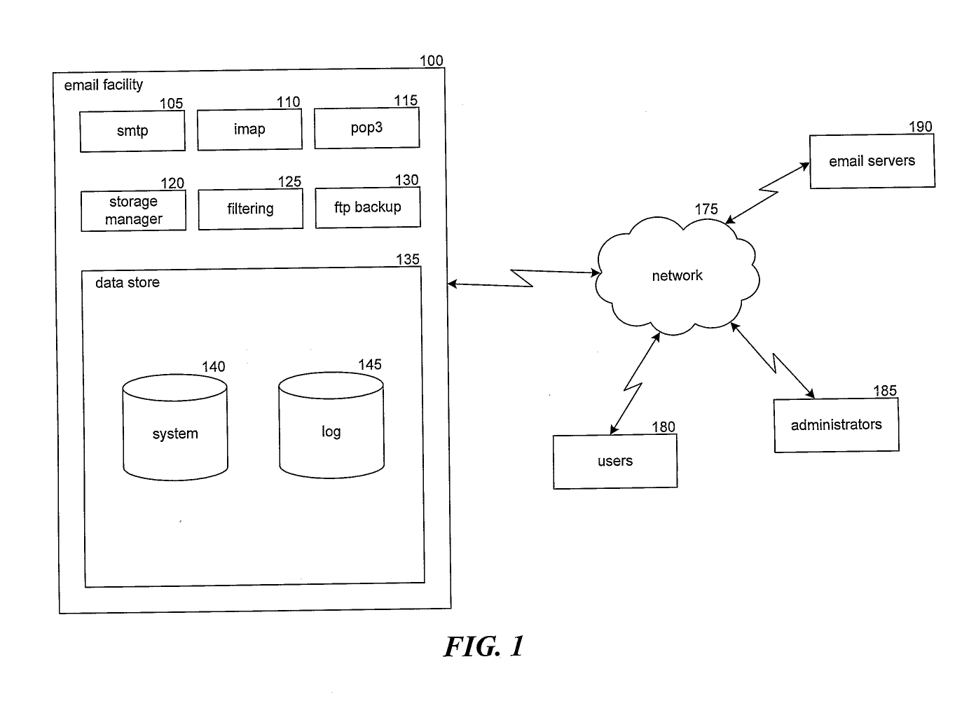

FIG. 1 is a block diagram illustrating components of an electronic mail/electronic message (“email”) software and/or hardware facility 100 (“the facility”). The facility 100 includes various components to implement the functions described herein, including a Simple Mail Transfer Protocol (SMTP) component 105, an Internet Message Access Protocol (IMAP) component 110, a Post Office Protocol 3 (POP3) component 115, a storage manager component 120, a filtering component 125, a File Transfer Protocol (FTP) backup component 130 and a data store 135. The SMTP component 105 sends and receives emails. The IMAP 110 and POP3 115 components provide access to users to emails stored by the facility. The data store 135 can include data storage units, such as system data storage unit 140, which stores system, email and other data related to the functioning of the facility, and log data storage unit 145, which stores log data that logs aspects of the functioning of the facility. Although depicted as single data storage units in FIG. 1, the system data storage unit 140 and the log data storage unit 145 can each be comprised of multiple data storage units. The data store 135 can also include other data stores and/or data storage units (not shown), such as an authentication/authorization data storage unit that contains access control lists with permissions or other authentication/authorization information.

The storage manager component 120 manages interactions with the data storage units, such as the system data storage unit 140. Aspects of the storage manager component are described in further detail in the co-pending patent application entitled SYSTEM AND METHOD FOR TRANSACTIONAL STORAGE OF EMAIL DATA (Attorney Docket No. 66253.8002US00), filed concurrently herewith and incorporated herein in its entirety by reference. The FTP backup component 130 allows connections from FTP clients that enable them to access data stored in the system data storage unit 140 for purposes of backing up and restoring such data. Aspects of the FTP backup component 130 are described in further detail in the co-pending patent application entitled SYSTEM AND METHOD FOR BACKING UP AND RESTORING EMAIL DATA (Attorney Docket No. 66253.8003.US00), filed concurrently herewith and incorporated herein in its entirety by reference. The filtering component 125 filters and/or otherwise processes emails in accordance with rules and/or policies defined by administrators of the facility. The facility can also include other components (not shown), such as a component that provides a web or internet interface to users for purposes of accessing their emails, a component that provides a web or internet interface to users administrators for purposes of administering the facility, and a component that enables administration of the facility with a command-line interface.

Users, such as users 180, can interact with the facility over a network 175, such as the Internet, for purposes of sending and receiving emails. The network 175 can also include an intranet or other private or non-public network. For example, administrators of the facility, such as administrators 185, may access the facility over a private, firewalled network that is only connected to a public network (e.g., the Internet) via a gateway device. The facility can also interact with external servers, such as email servers 190, over the network 175. Other entities (not shown) that may interact with the facility over, through or via the network 175 include routers, firewalls, application servers, database servers and other servers.

### 2. FILTERING LANGUAGE

The filtering component 125 filters and/or otherwise processes emails using one or more filters written in or translated into a filtering language and aggregated into a script file. The filtering language includes structural blocks of two types: event rules and methods. Event rules are structural blocks containing code that is executed at specific moments by the facility. These specific moments, hereinafter called “SMTP events,” include moments when the facility receives certain SMTP commands or moments before the facility takes certain actions. Event rules are executed in specific stages of the flow of email through the facility, and event rules have a context that corresponds to the specific stage. The following table lists representative event rules, their context, and the SMTP event when the event rule is executed:

| Event Rule | Context | When executed |
|---|---|---|
| onConnect | SMTP Incoming | Facility receives connection |
| onEhlo | SMTP Incoming | Facility receives EHLO command |
| onMailFrom | SMTP Incoming | Facility receives MAIL FROM command |
| onRcptTo | SMTP Incoming | Facility receives RCPT TO command |
| onHeadersReceived | SMTP Incoming | Facility receives email header |
| onDataReceived | SMTP Incoming | Facility receives email successfully |
| | | through DATA or BDAT commands |
| onRelay | SMTP Outgoing | Before establishing a relay connection |
| onDeliveryFailure | Processing | When email delivery failed for certain |
| | | group of recipients |
| onTemporaryDeliveryFailure | Processing | When email delivery has temporarily |
| | | failed for certain group of recipients |

Methods are structural blocks that can be called from within other structural blocks (i.e., event rules or methods). Methods can be predefined or custom. Predefined methods are methods that are predetermined for the performance of common functions associated with SMTP servers. Predefined methods can be associated with one or more event rules. A listing of representative predefined methods in the filtering language can be found in the Axigen® Mail Server User Manual for Product Version 4.0 (Document version 1.0, last updated 6/18/2007), which is hereby incorporated by reference. Custom methods are methods created by an administrator to perform custom functions. Methods can have as input one or more parameters and can have as output one or more parameters. Methods can be called using a function named call in the following manner:

call(method);

The filtering language also includes variables. Variables can also be predefined or custom. Predefined variables can also be associated with one or more event rules. A listing of representative predefined variables can be found in the previously-referenced Axigen® Mail Server User Manual for Product Version 4.0. Variables can be strings or numbers and can be one of three types: 1) read-only variables (input parameters); 2) read-write variables (input/output parameters); and 3) action variables, which can be either read-only or read-write and can either cause the facility to take an action or can be involved in an action. The value of a pre-defined variable can be set using a function named set in the following manner:

set(SPFResult, “some value”);

A custom variable can be defined and its value set also by using the set function:

set(customVariable, “custom value”);

The lifetime of a custom variable is only until the end of its containing block. However, a custom variable can be preserved across blocks and across contexts by exporting it using a function named export in the following manner:

export(aVariable);

The lifetime of a script file is the email to which the script file is being applied. The export function can be used to preserve the value of a variable specific to one email through the different SMTP contexts. For example, in the “SMTP Outgoing” context, the value of the MailFromDomain variable is not set but can be, if in one of the “SMTP Incoming” events, the MailFromDomain variable is exported using the export function. Variables can also be expanded by book-ending the variable with the “%” character within a string. For example, the following sets the value of a variable named avariable and expands it within a string:

set(aVariable, “Hello.”);
set(SMTPGreeting, “%aVariable% This is my AXIGEN server”);

The filtering language also includes condition structures, or control structures. The condition structures are if and switch structures. The if structure has the following form:

if (conditions) {
}
else {
}

The switch structure has the following form

switch (variable) {

case <value>: {
}
case <value>: {
}
default: {
}

}

The filtering language also includes conditions. Conditions are boolean functions that can be used within the if and switch structures. Conditions have one of two types: single conditions and logical groups. The following table lists each single condition and its description:

| Name | Description |
|---|---|
| is(variable,value) | matches for equality |
| isCase(variable,value) | matches for equality and if strings, the |
| | match is case insensitive |
| match(variable,regexp) | regular expression match |
| lessThen(variable,value) | number comparison |
| greaterThen(variable,value) | number comparison |
| greaterOrEqual(variable, value) | number comparison |
| lessOrEqual(variable, value) | number comparison |
| iprange(variable, range) | matches if the variable's value is in |
| | range. If the variable is not an IP |
| | address, the function returns false |

The following table lists each logical arum and its description:

| Name | Description |
|---|---|
| not(condition) | negation of a condition |
| allof(condition,condition,...) | similar to an AND between conditions |
| anyof(condition,condition,...) | similar to an OR between conditions |

The filtering language also includes functions. The functions include the conditions (boolean functions) previously described. The following table lists each function and its description:

| Name | Description |
|---|---|
| Boolean functions | All the boolean functions previously |
| | described |
| call(method) | Executes a predefined or custom |
| | defined method. If the method is custom |
| | defined, it is defined in the same script |
| | file as the method call |
| export(variable) | Exports a variable name and value to be |
| | used in another context. If the variable is |
| | custom defined it is defined in the same |
| | script file |
| set(variable, value) | Sets the value of a variable |
| return | Ends the current event rule or method |
| | execution |

An administrator can create filters using the above-described features of the filtering language to filter and/or otherwise process emails. For example, the following snippet from a script file sets the facility as a gateway for a domain “example.org” where the mailboxes are hosted by a server with the IP address 193.230.245.200:

event onEhlo {

set (remoteDelivery, “all”);

}
event onRcptTo {

if (allof(

not(is(isRcptDomainLocal, “yes”)),
not(is(currentRcptDomain, “example.org”))

)) {

set(smtpAction, “reject”);
set(smtpExplanation, “Relay denied for

<%currentRcptDomain%>”);

}

}
event onRelay {

if (is(remoteSmtpHost, “example.org”)) {

set(remoteSmtpIp, “193.230.245.200”);

}

}

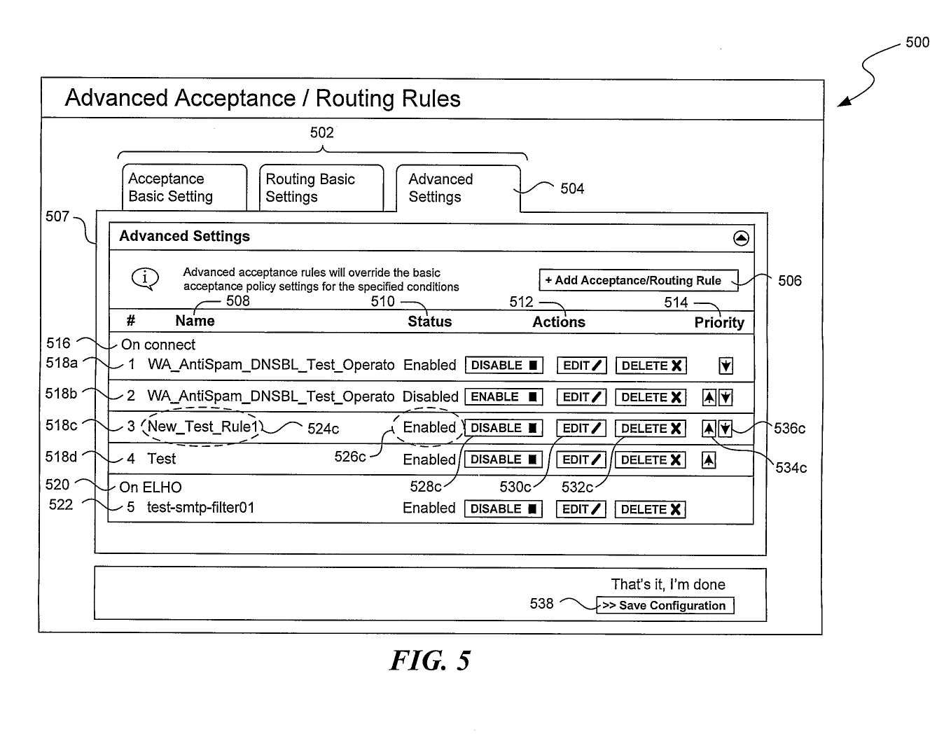

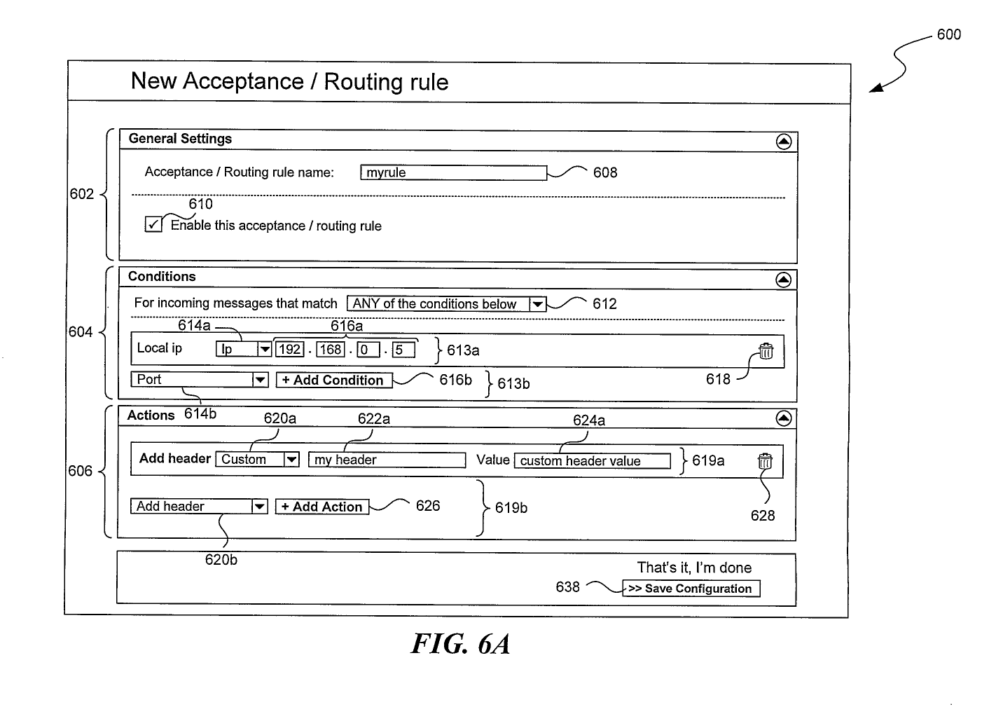

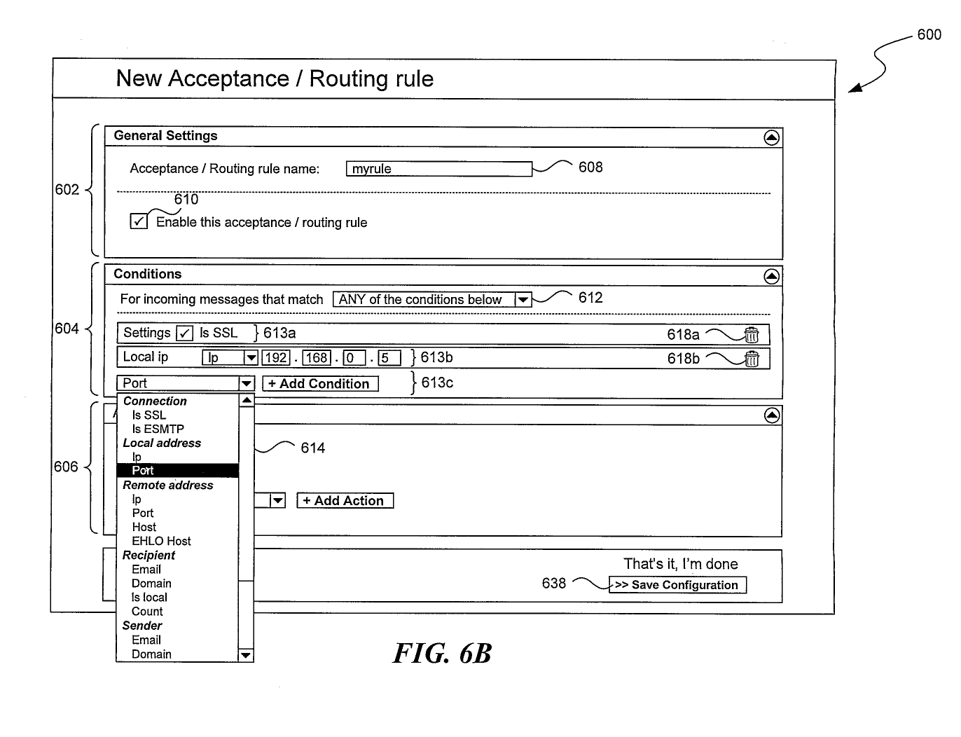

An administrator of the facility can directly create script files containing event rules and filters by writing them in the filtering language using an ASCII text editor or other software tool. Alternatively, the administrator can indirectly create script files using a graphical user interface (GUI) to a component that creates the script files in the filtering language. This latter method of creating script files is described in further detail with reference to FIG. 5 and FIGS. 6A and 6B. The facility loads the script files at run-time, interprets them and executes the interpreted script files with a scripting engine to filter and/or otherwise process emails.

The filtering language implemented by the facility offers several advantages. One advantage is that each event rule in the filtering language corresponds to a specific SMTP event (e.g., an SMTP command or an SMTP protocol event). This correspondence enables an administrator to control how emails flow through the facility at specific stages. A second advantage of the filtering language is that it includes multiple predefined methods for the performance of common functions associated with SMTP servers. This obviates the need for administrators to create custom methods to perform those functions. A third advantage is that since actions are taken by setting the value of action variables, the scripting engine can take those actions when the threads are run instead of making the threads wait for the filtering language to execute. Moreover, the scripting engine can set those action variables to their default values (actions). A fourth advantage of the filtering language is that it is very light-weight, because it does not have cycle blocks and because actions are taken by setting action variables. This allows the script engine to execute interpreted script files quickly, thus not affecting the rate at which the facility processes emails. A fifth advantage is that the filtering language can easily be extended without extensive modifications or any modifications to the interpreter and the script engine. A sixth advantage is that the structure of the filtering language enables the creation of GUIs (e.g., wizards for creating filters) for creating script files in the filtering language. This allows administrators to use GUIs to create script files in the filtering language that express rules and/or policies to be implemented by the facility in filtering and/or otherwise processing emails.

### 3. FILTERING EMAILS

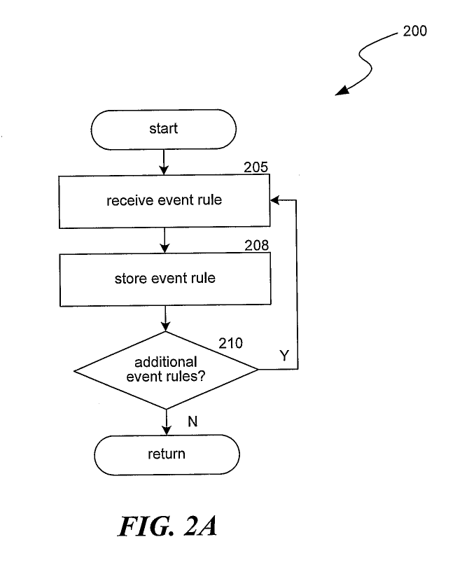

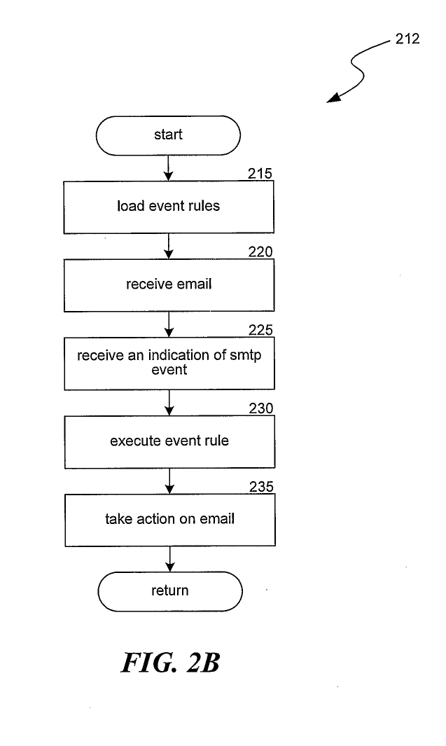

FIG. 2A is a flow diagram of a process 200 implemented by the facility for the creation of event rules used to filter emails. The process 200 begins at block 205 when the facility receives a definition of an event rule corresponding to an SMTP event. The event rule can be contained in a script file and contain code written in the previously-described filtering language, and may be defined by a user or a system administrator. At block 208 the facility stores the event rule, such as by storing the script file on persistent storage (e.g., a hard drive) or in memory. At block 210, the facility determines whether any additional event rules are to be defined. If additional rules are defined, processing continues at block 205 where an additional event rule is received. If no additional rules are defined, the processing ends. It will be appreciated that the process 200 may be executed at any time by the facility in order to receive new event rules from a user or an administrator.

FIG. 2B is a flow diagram of a process 212 implemented by the facility to filter emails in accordance with event rules. At block 215 the facility loads one or more event rules, such as by loading event rule code into memory. At block 220 the facility receives an email. The facility can receive emails from external entities, such as users sending emails to the facility for delivery to other users, or email servers sending emails to the facility for delivery to users of the facility. In this context, receiving an email can also refer to receiving a connection or any SMTP command (e.g., EHLO, MAIL FROM, RCPT TO, etc.) from an external entity. At block 225 the facility receives an indication of the occurrence of an SMTP event (e.g., the receipt of the email triggers the SMTP event). At block 230 the facility executes the event rule corresponding to the triggered SMTP event. Executing the event rule refers to executing any code in the event rule (e.g., calling functions, calling methods, setting values of variables, etc.). At block 235 the facility takes action on the email in some manner. In this context, taking action on an email can refer to actions that affect the email, such as adding, removing or modifying email headers, adding, removing or modifying other aspects of the email, routing the email to a recipient other than the recipient specified, rejecting the email, delivering the email to a folder of the recipient other than the recipient's inbox, creating and sending a new email to a particular destination, or any other operation that filters or otherwise acts on the email. Taking action on an email can also refer to actions that affect multiple emails, such as modifying or configuring the facility's settings, adding an entry to a DNS blacklist, or any other operation that affects multiple emails. Examples of configuring the facility's settings include, but are not limited to, configuring the facility to: require secure connections (e.g., encrypting the data via SSL); deny certain connections; reroute or redirect emails from certain IP addresses (or portion of the certain IP addresses); reject emails from certain senders (e.g., senders with IP addresses or domain names on a DNS blacklist); deny relaying privileges to certain senders; and redirect emails sent to certain recipients. Taking action on an email can also refer to responding to a connection or an SMTP command, such as accepting the connection or command, rejecting the connection or command, temporarily rejecting the connection or command or any other operation that filters or otherwise acts on the connection or command. The process 212 then concludes.

### 4. EMAIL FLOW

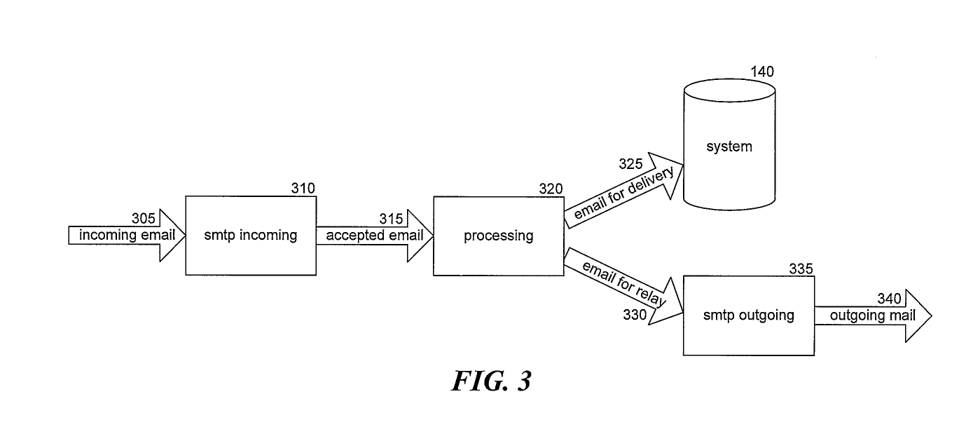

FIG. 3 is a block diagram that illustrates a flow of emails through the facility. An SMTP incoming component 310 receives incoming email 305. The SMTP incoming component 310 executes event rules in a script file loaded by the facility to filter and/or otherwise process the incoming email 305. These event rules include the event rules that have a context of “SMTP Incoming,” that is, onConnect, onEhlo, onMailFrom, onRcptTo, onHeadersReceived, and onDataReceived. The execution of these event rules can result in the facility either accepting the incoming email and sending it to the next stage or rejecting the incoming email. Incoming email that has been accepted by the facility becomes accepted email 315 and proceeds to a processing component 320. The processing component 320 can execute event rules that have a context of “Processing,” that is, onDeliveryFailure and onTemporaryDeliveryFailure. The execution of these event rules can result in the facility either sending the accepted email 315 to the next stage or rejecting the accepted email. Email that the processing component has further accepted either becomes email for delivery 325 (e.g., email to be delivered to local recipients) and sent to storage (e.g., the system data storage unit 140) or it becomes email for relay 330 (e.g., email to be relayed to other email servers) and sent to an SMTP outgoing component 335. The SMTP outgoing component 335 can execute the event rule that has a context of “SMTP Outgoing,” that is, on Relay. The execution of this event rule can result in the facility either accepting the email for relay or rejecting the email for relay. Email that the facility has accepted becomes outgoing email 340 and is sent on (e.g., relayed to other email servers).

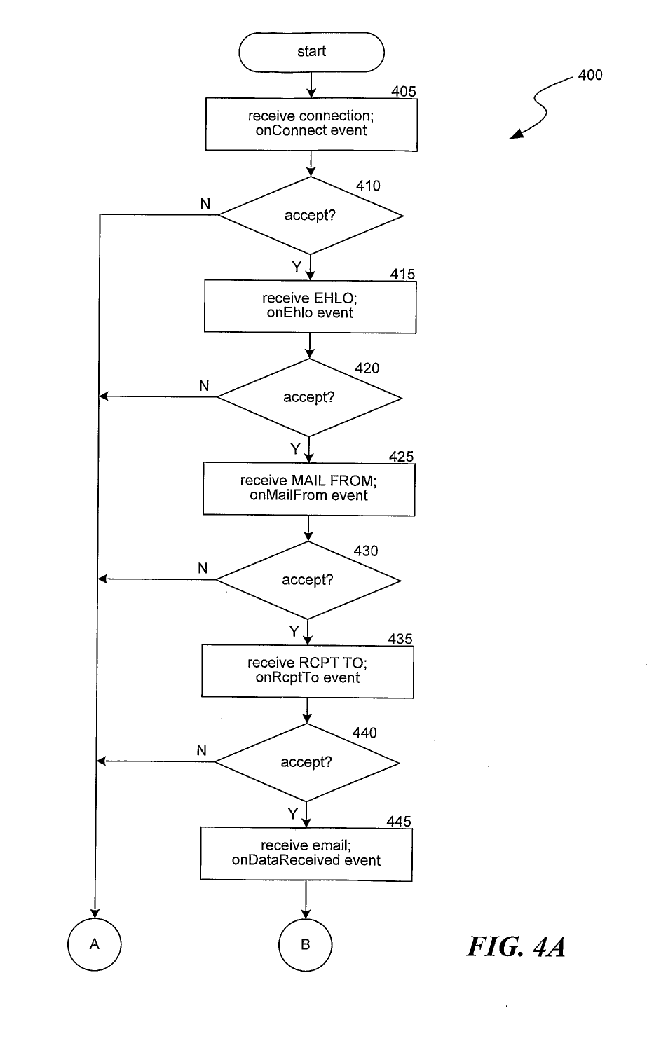

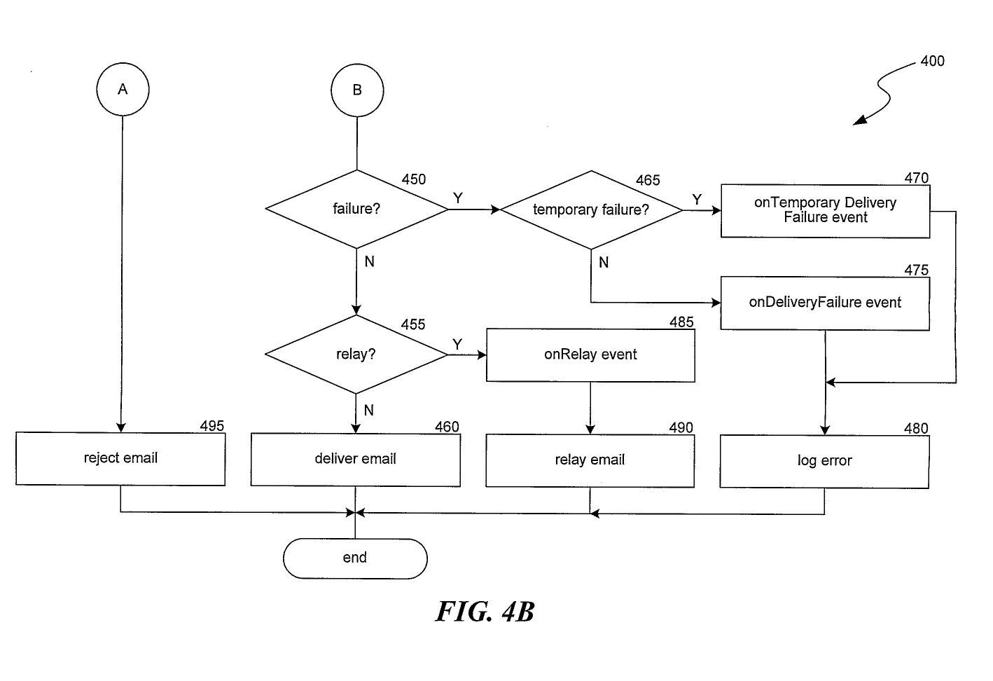

FIGS. 4A and 4B are a flow diagram of another process 400 implemented by the facility for filtering and/or otherwise processing an email. The facility can have already loaded any filtering language script files that include event rules that affect how the facility filters and/or otherwise processes the email at the outset of the process 400. The process 400 begins at block 405 when the facility receives a connection (e.g., a connection from another email server or a connection from a user). The receipt of the connection triggers the onConnect event, thereby causing the facility to execute any code in the associated event rule. At block 410 the facility determines whether the executed event rule causes it to accept the connection to the requesting entity or to reject it. For example, the facility can reject the connection if the code in the onConnect event rule directs the facility to reject connections from entities with certain IP addresses. If the connection is accepted, the process 400 continues to block 415, at which the facility receives the “EHLO” command from the connected entity. This triggers the onEhlo event, thereby causing the facility to execute any code in the associated event rule. At block 420 the facility determines whether the event rule code causes it to accept or reject the “EHLO” command from the connected entity. If the “EHLO” command is accepted, the process 400 continues to block 425, at which the facility receives the “MAIL FROM” command from the connected entity. The receipt of the “MAIL FROM” command triggers the onMailFrom event, which causes the facility to execute any code in the associated event rule. At block 430 the facility determines whether the event rule code causes it to accept or reject the “MAIL FROM” command from the connected entity. For example, the facility can reject the “MAIL FROM” command if the code in the onMailFrom event rule directs the facility to reject entities with a specific email address or entities that do not supply an email address. If the “MAIL FROM” command is accepted, the process 400 continues to block 435, at which the facility receives the “RCPT TO” command from the connected entity. The receipt of the “RCPT TO” command triggers the onRcptTo event, which causes the facility to execute any code in the associated event rule. At block 440 the facility determines whether the event rule code causes it to accept or reject the “RCPT TO” command from the connected entity. For example, the facility can reject the “RCPT TO” command if the code in the onRcptTo event rule directs the facility to reject entities attempting to send an email to a specific email address or to non-existing email addresses. If the “RCPT TO” command is accepted, the process 400 continues to block 445, at which the facility receives the email (e.g., the email header data and/or the email message data) from the connected entity, thereby triggering the onDataReceived event and causing the facility to execute any code in the associated event rule.

Turning to FIG. 4B, the process 400 continues at block 450, at which the facility determines whether there is a failure in the receipt of the email or whether the code in the onDataReceived event rule causes it to indicate a failure. If the facility determines that there is a failure, the process 400 continues at block 465, at which the facility determines whether the failure is temporary. For example, the failure can be a temporary one if the facility did not receive the entire email from the connected entity but is able to subsequently receive it. If the failure was temporary, the process 400 continues at block 470, at which the onTemporaryDeliveryFailure event is triggered and the facility executes the code in the associated event rule. If the failure was not temporary, the process 400 continues at block 475, at which the onDeliveryFailure event is triggered and the facility executes the code in the associated event rule. In either case the process 400 continues at block 480 in which the facility logs the error and the process 400 finishes.

If, at block 450, the facility determines that there is not a failure, the process 400 continues at block 455, at which the facility determines whether the email is to be relayed to another entity or delivered (e.g., to a local mailbox). If the email is to be relayed, the process 400 continues at block 485, at which the on Relay event is triggered, thereby causing the facility to execute the code in the associated event rule. The email is then relayed at block 490 and the process 400 terminates. If the email is to be delivered, the process continues at block 460 at which the facility delivers the email and the process 400 ends. In any of the blocks (410, 420, 430, 440) at which the facility determines that the email (or connection or command) is to be rejected, the process 400 continues at block 495, at which the email (or connection or command) is rejected. The process 400 then concludes.

One advantage of the process 400 is that specific SMTP events (e.g., an SMTP command or an SMTP protocol event) can correspond to event rules written in the filtering language. This enables the facility to take actions defined in the event rules corresponding to the specific SMTP events. Those of skill in the art will understand that the facility can take actions in response to SMTP events other than those described (e.g., SMTP commands as defined in RFC 821 and subsequent RFCs amending RFC 821, which are incorporated by reference herein). The filtering language can also include events, methods and variables corresponding to the SMTP events that are not described herein.

### 5. EVENT RULE AND FILTER ADMINISTRATION INTERFACES

FIG. 5 is a representative screenshot depicting an interface 500 implemented by the facility to allow users or administrators (collectively referred to as “administrators”) to administer event rules and filters. The interface 500 includes a tabbed interface 502 for administering various aspects of the facility. Tab 504, labeled “Advanced Settings,” is currently active. The region 507 includes various columns that display various attributes or properties of filters. These columns include a name column 508 which displays the name of the filter, a status column 510 indicating whether the filter is enabled or disabled, an actions column 512 that enables an administrator to edit or delete a filter, and a priority column 514, which enables an administrator to change the order within the corresponding event rule in which the filter is executed. An administrator can add a new filter by clicking button 506, labeled “Add Acceptance/Routing Rule.”

The first four filters 518 (shown individually as filters 518a-d) in region 507 correspond to the event rule “onConnect” 516. Therefore, the first four filters 518 (if enabled) will be executed when the SMTP event corresponding to the event rule onConnect is triggered (e.g., when the facility receives a connection). Filter 522 corresponds to the event rule “onEhlo” 520, meaning that it will be executed when the SMTP event corresponding to the event rule onEhlo is triggered (e.g., when the facility receives the EHLO command). Filter 518c has as a name “New_Test_Rule1” 524c and its status is enabled, as indicated by element 526c. The administrator can disable the filter 518c by clicking the button 528c labeled “Disable.” The administrator can also edit the filter 518c by clicking the “Edit” button 530c and delete the filter 518c by clicking the “Delete” button 532c. As currently depicted, the filter 518c has third priority in the list of filters, meaning that it will be executed after the previous two filters. The administrator can raise the priority of the filter 518c by clicking “up arrow” button 534c or can lower its priority by clicking “down arrow” button 536c. Once the administrator has finished administering the event rules and filters the administrator can save the configuration by clicking button 538, labeled “Save Configuration.”

FIGS. 6A and 6B are representative screenshots depicting an interface 600 implemented by the facility to allow an administrator to define a new filter. The facility displays the interface 600 after the administrator clicks on the “Add Acceptance/Routing Rule” button 506 of the interface 500 of FIG. 5. The interface 600 includes three primary regions. A first primary region 602 allows the administrator to provide general settings of the filter, including providing a name in textbox 608 and enabling the filter by checking checkbox 610. A second primary region 604 enables the administrator to define conditions for the filter. The administrator can specify whether the incoming emails are required to match any of the conditions, all of the conditions, or none of the conditions (corresponding to the logical groups anyof, allof and not, respectively) in drop-down list 612. A first condition 613a has been specified, consisting of a criterion (“ip,” i.e., IP address) in drop-down list 614a and values in text boxes 616a. The operator (the is single condition) is implied in condition 613a. Other single conditions (e.g., match, greaterThen, lessOrEqual, iprange, etc) can be expressly specified. The administrator can delete the first condition 613a by clicking on the trash can icon 618. The administrator can specify a second condition 613b by selecting a criterion in drop-down list 614b and clicking the button 616b (labeled “+Add Condition”) to add an operator (i.e., single condition) and a value. The facility implements the conditions in the filtering language using the control structures (e.g., the if structure) previously discussed. In other words, the facility transforms the conditions specified in the second primary region 604 into code composed in the filtering language.

After specifying conditions, the administrator can specify actions in a third primary region 606. A first action 619a has been specified, which directs the facility to add a custom header (as selected in drop-down list 620a) with a name of “myheader” (as indicated in text box 622a) and a value of “custom header value” (as indicated in text box 624a). The administrator can delete the first action 619a by clicking on the trash can icon 628. The administrator can specify a second condition 619b by making a selection in drop-down list 620b and clicking button 626 (labeled “+Add Action”). The facility transforms the actions specified in the third primary region 606 into code composed in the filtering language that is included within the control structures of the corresponding conditions. Once the administrator has finished specifying the general settings, conditions and actions, the administrator can save the newly defined filter by clicking button 638, labeled “Save Configuration.” In some embodiments, after clicking the “Save Configuration” button 638, the facility determines, based upon the conditions specified by the administrator, which event rule the new filter corresponds to, and places the filter in that corresponding event rule. The facility can either place the filter in first priority, last priority, or make a suitable priority determination. In other embodiments, the facility requests that the administrator specify which event rule the new filter corresponds to and the new filter's priority within that event rule.

The interface 600 of FIG. 6B has similar aspects to the interface 600 of FIG. 6A and thus these similarities will not be discussed again. In condition 613c, drop-down list 614 illustrates the various criteria that the administrator can select in creating a condition. These include criteria relating to the connection between the facility and the remote server/client (e.g., “Is SSL” refers to whether the connection is an SSL connection), criteria relating to the local IP address (e.g., “Ip” refers to the facility's IP address), criteria relating to the remote IP address (e.g., “Port” refers to the port of the remote server/client), criteria relating to the recipient (e.g., “Email” refers to the recipient's email address) and criteria relating to the sender (e.g., “Domain” refers to the sender's domain name). In some embodiments, these criteria map to predefined variables in the filtering language. In other embodiments, these criteria do not map to predefined variables. The drop-down list 614 can also include other criteria (not shown) that the administrator can select to create conditions.

One advantage of the interfaces 500 of FIGS. 5 and 600 of FIGS. 6A and 6B is that such interfaces enable administrators to quickly and easily create event rules and/or filters for filtering and/or otherwise processing emails. This advantage is created by the clear structure of the filtering language, which enables the creation of interfaces for creating event rules and/or filters in the filtering language. The interfaces allow administrators to quickly and easily create event rules and/or filters that range in complexity from the very simple (e.g., a filter directing the facility to reject all emails from a certain IP address) to the very complex (e.g., event rules and filters implemented by the facility for the purposes of reducing or eliminating unsolicited commercial email—spam email).

### 6. CONCLUSION

The foregoing description details certain embodiments of the invention. It will be appreciated, however, that no matter how detailed the foregoing appears in text, the invention can be practiced in many ways. For example the facility can be implemented as a distributed computing system, with components of the facility being implemented and/or executed on disparate systems that are connected over a network. The facility could equally well be executed as a standalone system. Moreover, the facility may utilize third-party services and data to implement all or portions of its functionality. Although the subject matter has been described in language specific to structural features and/or methodological steps, it is to be understood that the subject matter defined in the claims is not necessarily limited to the specific features or steps described. Rather, the specific features and steps are disclosed as preferred forms of implementing the claimed subject matter.

The above Detailed Description of embodiments of the invention is not intended to be exhaustive or to limit the invention to the precise forms disclosed. While various embodiments are described in terms of the environment described above, those skilled in the art will appreciate that various changes to the facility may be made without departing from the scope of the invention. For example, those skilled in the art will appreciate that the actual implementation of the data store 135 may take a variety of forms. The term “data store” is used herein in the generic sense to refer to any data structure that allows data to be stored and accessed, such as databases, tables, linked lists, arrays, etc. As another example, while processes or blocks are presented in a given order, alternative embodiments may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel, or may be performed at different times.

These and other changes can be made to the invention in light of the above Detailed Description. Accordingly, the actual scope of the invention encompasses not only the disclosed embodiments, but also all equivalent ways of practicing or implementing the invention under the final claims.

I/We claim:

1. A method of processing emails in an email system, the method comprising:
receiving an indication of an SMTP event associated with an email;
processing a script corresponding to the SMTP event, wherein the script is composed in a language for processing emails and may comprise one or more filters; and
if the script includes one or more filters, executing the one or more filters and taking action on the associated email in accordance with the executed one or more filters, wherein taking action includes configuring the email system to affect not only the associated email but other emails.

2. The method of claim 1 wherein the SMTP event includes accepting a connection from an entity having an IP address or domain and taking action includes configuring the email system to deny connections from entities having the IP address or domain.

3. The method of claim 1 wherein the SMTP event includes receiving an indication of a sender of the associated email and taking action includes configuring the email system to reject the associated email and other emails having the same sender.

4. The method of claim 1 wherein the SMTP event includes receiving an indication of a recipient of the associated email and taking action includes configuring the email system to redirect the associated email and other emails having the same recipient.

5. The method of claim 1 wherein the SMTP event includes receiving header data of the associated email and taking action includes modifying the header data.

6. The method of claim 1 wherein the SMTP event includes receiving message data of the associated email and taking action includes modifying the message data.

7. The method of claim 1 wherein the SMTP event includes receiving an indication of a delivery failure of the associated email and taking action includes sending an email including an indication of the delivery failure.

8. The method of claim 1 wherein the SMTP event includes an indication of a relay and taking action includes refusing the relay.

9. A method of filtering emails in an email system having a plurality of configuration settings, the method of filtering emails comprising:
receiving an email, the receipt of the email triggering an SMTP event;
accessing one or more event rules in order to identify an event rule corresponding to the triggered SMTP event, wherein the identified event rule includes one or more filters that when executed cause an action to be taken on an email; and
executing an appropriate filter within the event rule and taking action on the received email in accordance with the executed filter, wherein taking action includes configuring the email system.

10. The method of claim 9, further comprising receiving a definition of the one or more event rules.

11. The method of claim 10 wherein the one or more event rules are defined in a language for filtering emails.

12. The method of claim 9 wherein the email system accepts connections and taking action includes configuring the email system to require secure connections.

13. The method of claim 9 wherein the email system accepts connections and taking action includes configuring the email system to deny certain connections.

14. The method of claim 9 wherein taking action includes configuring the email system to reroute certain received emails.

15. A system for filtering emails, the system having a plurality of configuration settings and comprising:
an input component configured to receive emails, wherein the receipt of an email triggers an SMTP event;
an event rule component configured to identify an event rule corresponding to the triggered SMTP event, wherein the identified event rule includes one or more filters that when executed cause an action to be taken on an email; and
a filtering component configured to:
execute an appropriate filter within the event rule; and
take action on the received email in accordance with the executed filter, wherein taking action includes modifying a configuration setting of the system.

16. The system of claim 15, further comprising an interface component configured to receive a filter definition.

17. The system of claim 16 wherein the interface component is further configured to display a graphical interface that enables creation of the filter definition.

18. The system of claim 16, further comprising a transform component configured to transform the received filter definition to a filter included in an event rule, wherein the filter included in the event rule is composed in accordance with a language for filtering emails.

19. The system of claim 18, further comprising an interpreter component configured to interpret the filter included in the event rule.

20. The system of claim 15 wherein taking action includes configuring the input component to refuse certain emails.

21. A method of processing emails in an email system, the method comprising:
retrieving an event rule corresponding to an SMTP event, wherein the event rule includes a call to a function that sets a value of at least one variable;
receiving an email, the receipt of the email triggering the SMTP event;
executing the event rule in response to the SMTP event, wherein executing the event rule includes setting the value of the at least one variable; and
taking action on the received email, wherein the action taken is determined entirely by the value of the at least one variable.

22. The method of claim 21 wherein the at least one variable is a first variable having a first value, the event rule further includes a call to a boolean function that compares a second variable with a second value, and executing the event rule further includes calling the boolean function to compare the second variable with the second value.

23. The method of claim 22 wherein the received email has attributes, the second variable has a third value, and the third value is determined by an attribute of the received email.

24. The method of claim 21 wherein the received email has attributes and taking action on the received email includes modifying an attribute of the received email.

25. The method of claim 21, further comprising receiving a definition of the event rule.
